(19) United States
(12) Patent Application Publication
(10) Pub. No.: US 2020/0131818 A1
(43) Pub. Date: Apr. 30, 2020

(54) FLAP FITTING AND ITEM OF FURNITURE

(71) Applicant: HETTICH-ONI GMBH & CO. KG, Vlotho (DE)

(72) Inventors: Uwe SOBOLEWSKI, Bünde (DE); Stefan ANDSCHUS, Lübbecke (DE); Michael TASCHE, Bielefeld (DE); Oliver SCHAEL, Kirchlengern (DE)

(21) Appl. No.: 16/628,142

(22) PCT Filed: Jun. 26, 2018
(86) PCT No.: PCT/EP2018/067151

§ 371 Date: Jan. 2, 2020

(30) Foreign Application Priority Data
Jul. 3, 2017 (DE) 10 2017 114 774.8

(51) Int. Cl. E05D 3/12; E05F 1/12; E05D 15/40

(52) U.S. Cl. CPC E05D 3/122; E05Y 2900/20; E05D 15/401; E05F 1/1269

(57) ABSTRACT

The invention relates to a shutter fitting, in particular for a piece of furniture, said fitting comprising a housing which can be fixed to a body, on which housing a supporting arm is mounted rotatably, and comprising a pivotably mounted control arm, wherein the supporting arm and the control arm can be hingedly connected to a shutter via spaced-apart axes of rotation, wherein the supporting arm drives a first gearwheel in the event of a rotary movement, which first gearwheel directly or indirectly drives a second gearwheel, wherein the control arm is rotatably mounted on the second gearwheel at a distance from the axis of rotation of the second gearwheel, and to a piece of furniture comprising a shutter fitting of this kind.

### BACKGROUND AND SUMMARY OF THE INVENTION

Exemplary embodiments of the present invention relate to a flap fitting, in particular for an item of furniture, having a housing, which is fixable on a body, and on which a supporting lever is rotatably mounted, and a pivotably mounted control lever, wherein the supporting lever and the control lever can be articulated with a flap via spaced-apart axes of rotation, and the supporting lever drives a first gear wheel during a rotational movement, which directly or indirectly drives a second gear wheel, and an item of furniture having a furniture body on which a flap is held via two flap fittings.

EP 1 705 328 B1 discloses an opening and closing device for a flap door, in which the flap is held on two rotatable arms. The arms are coupled to one another via regions having gear teeth, so that during opening, the flap pivots through the two arms. This flap fitting has the disadvantage that the flap covers on open region of the furniture body in the collapsed state and the user has to apply comparatively large forces in the vertical direction for an opening movement.

EP 2 138 658 B1 discloses a flap fitting for a furniture flap, in which the furniture flap is pivotable by a positioning arm and a control lever. The pivot arm is mounted around a fixed axis of rotation in this case, while the control lever is linked via a linkage axis movable on a bearing part. The pivot movement of the furniture flap can thus be guided in the desired movement path, however, in particular in the starting range of the opening movement, sluggishness can occur.

Accordingly, exemplary embodiments of the present invention are directed to a flap fitting having an optimized movement sequence for opening and closing the flap.

In the flap fitting according to the invention, a supporting lever is provided, which drives a first gear wheel during a rotational movement, which directly or indirectly drives a second gear wheel, wherein the control lever is rotatably mounted on the second gear wheel spaced apart from the axis of rotation of the second gear wheel. The supporting lever and the control lever are thus coupled to one another in their movement via the gear wheels, so that a mechanical guide by the supporting lever and the control lever is performed over the entire movement range of the flap. Due to the coupling via the gear wheels, a smooth movement can be set via a force accumulator, which substantially compensates for the weight forces.

A force accumulator is therefore preferably provided, which pre-tensions the flap in a closed position in the closing direction and which pre-tensions the flap in an opening range in the opening direction. The user then only has to overcome the closing forces of the force accumulator for an opening movement and move the flap up to an opening range, in which the force accumulator automatically pre-tensions and moves the flap in the opening direction. The opening range can begin, for example, viewed from the closing position, at between 20% to 50% of the total movement range of the flap, so that only a slight opening movement by the user is required and then the flap is movable further in the opening direction via the force accumulator.

The force accumulator is preferably coupled via a rotatably mounted control disk to at least one gear wheel. A curve guide can be formed in the control disk in this case, on which a holder connected to the force accumulator is guided. The force accumulator can comprise one or more springs here, in particular traction springs, which are tensioned in the housing of the flap fitting.

For a compact construction, a gearing formed from multiple gear wheels can be provided between two side walls of the housing. Due to the use of gear wheels, it is possible to set the forces for moving the flap, and in particular the axis of rotation of the control lever can be changed to ensure a harmonic movement sequence.

To avoid a hard impact, at least one damper can be provided, by means of which an opening and/or closing movement of the flap is decelerated before reaching the end position.

For simple mounting, an attachment can be installable on the flap, on which the axis of rotation for the supporting lever and the axis of rotation for the control lever are provided, so that the spacing of the two axes of rotation is predetermined by the attachment. In addition, a damper for decelerating an opening movement of the flap can be provided on the attachment. The damper can also assume a holding function here, to ensure a fixation of the flap in a certain opening range if the user lets go of the flap.

The attachment can be formed both in one part and also multiple parts.

In the pivot fitting, the flap is preferably moved during an opening movement with an upper section away from the flap fitting, i.e., forward toward the user. The flap thus protrudes upward into the space, so that an opening range on the furniture body can be completely used, in particular if the lower region of the flap is arranged in the maximally open position in the region of the top panel of the cabinet furniture. The flap can be formed as a dimensionally-stable front panel in this case, or also as a pivot flap, which consists of two or more parts and is collapsed during the opening movement.

### BRIEF DESCRIPTION OF THE DRAWING FIGURES

The invention is explained in greater detail hereafter on the basis of an exemplary embodiment with reference to the appended drawings. In the figures:

FIG. 1 shows a perspective view of an item of furniture according to the invention having a flap fitting;

FIG. 2 shows a perspective view of the front panel having a flap fitting;

FIGS. 3A and 3B show two views of the item of furniture of FIG. 1 having an open flap;

FIGS. 4A and 4B show two views of the pivot fitting in a closed position;

FIG. 5 shows a view of the pivot fitting having partially removed housing in a closed position;

FIGS. 6 to 8 show multiple views of the flap fitting of the figure in different positions;

FIG. 9 shows a view of the flap fitting in an open position, and

FIG. 10 shows a view of a modified flap fitting which is arranged in a side wall of an item of furniture.

### DETAILED DESCRIPTION

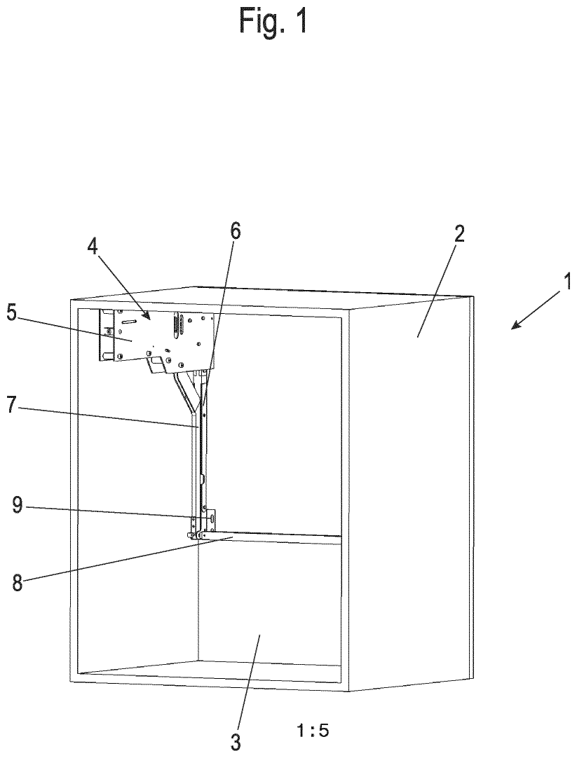

An item of furniture 1 comprises a furniture body 2, for example, for a hanging cabinet in a kitchen, in which the rear wall was omitted in FIG. 1. The furniture body 2 is closed by a flap 3 mounted in a pivotable manner on a front side. A flap fitting 4, which comprises a housing 5, is installed in each case on opposing side walls of the furniture body 2 for guiding the flap 3. Each flap fitting 4 comprises a supporting lever 6 and a control lever 7, which are connected via an attachment 9 to the flap 3. The two attachments 9 of the opposing flap fittings 4 are synchronized via a rod 8, so that the flap fittings 4 are moved essentially synchronously during the opening and closing of the flap 3.

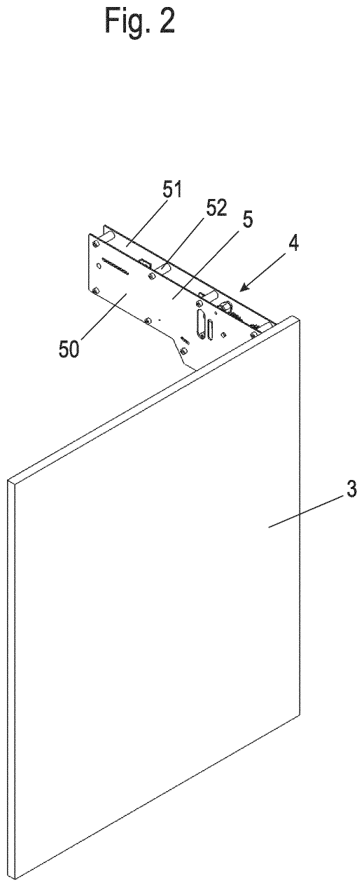

A flap fitting 4 having the flap 3 without furniture body 2 is shown in FIG. 2. The housing 5 of the flap fitting 4 comprises two side walls 50 and 51, which are arranged spaced apart from one another via a plurality of spacers 52. Other housing forms can also be used for the housing 5.

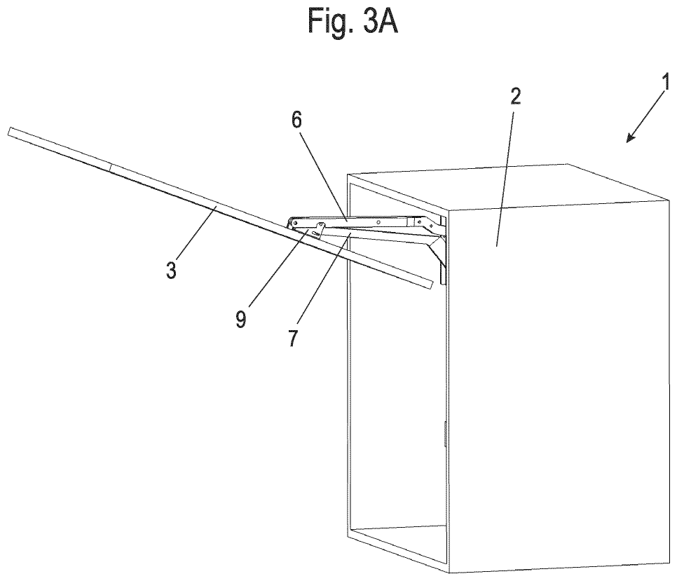

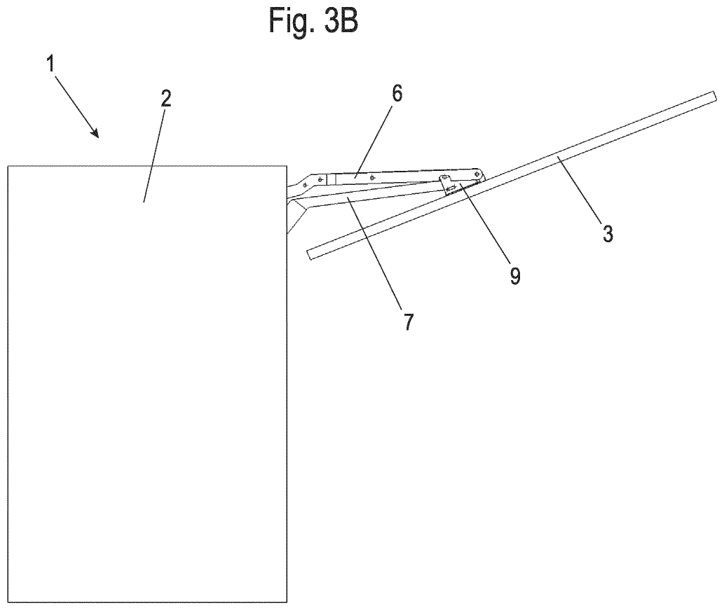

The flap 3 is shown in an open position in FIGS. 3A and 3B. The flap 3 has been pivoted with an upper region forward and away from the furniture body 2, while a lower region of the flap 3, on which a handle element (not shown) is installed, was pivoted essentially vertically upward. The user thus only has to execute a slight horizontal movement and essentially a vertical movement during the opening and closing of the flap 3.

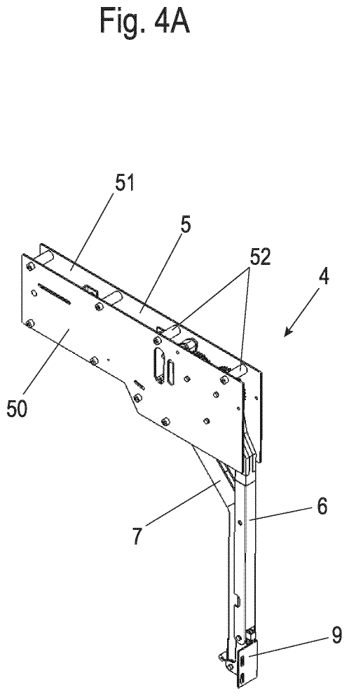

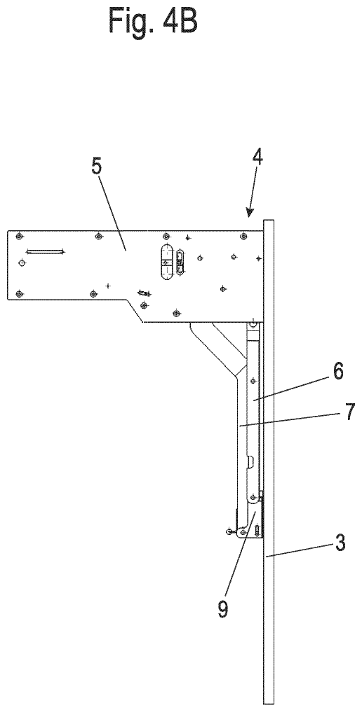

The flap fitting 4 is shown in a closed position in FIGS. 4A and 4B. The supporting lever 6 and the control lever 7 are arranged partially in parallel to one another and extend essentially in the vertical direction up to the attachment 9, which is installed on the flap 3.

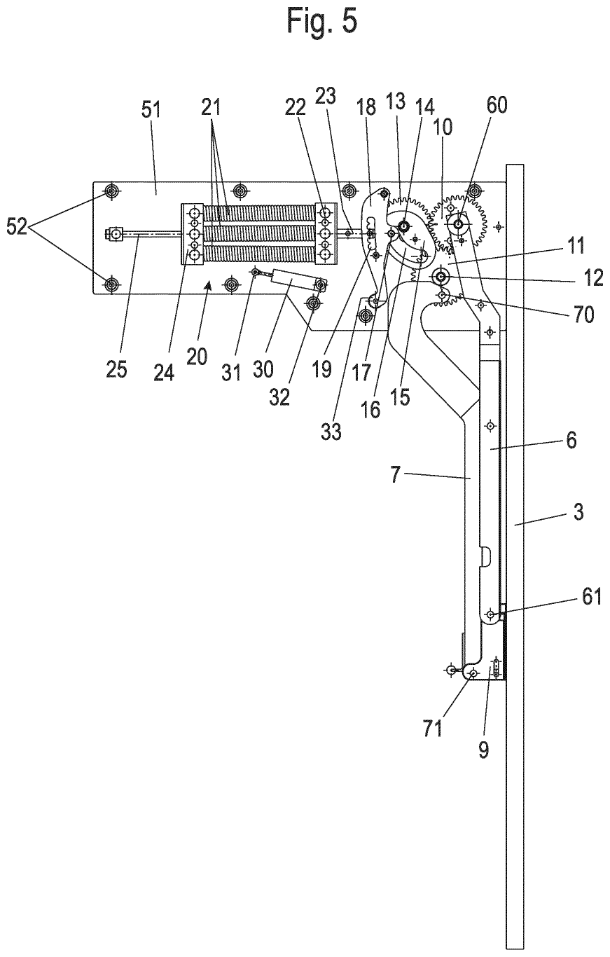

In FIG. 5, the flap fitting 4 is shown in a closed position without the side wall 50 of the housing. The supporting lever 6 is articulated at one end around an axis of rotation 61 on the attachment 9 and on the opposing side around an axis of rotation 60, which is provided on the housing 5. A first gear wheel 10, which is engaged with a second gear wheel 11, which is rotatably mounted around an axis of rotation 12 on the housing 5, is connected to the supporting lever 6 for conjoint rotation around the axis of rotation 60.

An axis of rotation 70, on which the control lever 7 is rotatably mounted, is provided on the second gear wheel 11 spaced apart from the axis of rotation 12 of the gear wheel 11. The control lever 7 is rotatably mounted around an axis of rotation 71 on the attachment 9 at the opposing end. The axis of rotation 70 thus moves during an opening and closing procedure of the flap 3, which is held on the attachment 9.

To partially compensate for the weight forces of the flap 3 during the opening and closing, a force accumulator 20 is provided, which comprises three springs 21, in particular traction springs in the illustrated exemplary embodiment, which are arranged between a first spring holder 22 and a second spring holder 24. The second spring holder 24 is fixed in this case via a fastening 25 on the housing 5. The spring holder 22 is connected via a rod 23 to a movable holder 18. A receptacle 19 is provided on the holder 18, on which the rod 23 of the force accumulator 20 is fixed, so that the holder 18 is pre-tensioned by the force accumulator 20. The holder 18 comprises a guide element 17, which is mounted in a curve guide 16 of a control disk 15. The control disk 15 is rotatably mounted here around an axis of rotation 14, which is provided on the housing 5. Furthermore, the control disk 15 is coupled for conjoint rotation to a third gear wheel 13, which is engaged with the first gear wheel 10.

Various positioning options for the positioning of the rod 23 of the force accumulator 20 are formed on the receptacle 19 of the holder 18, so that an optimum presetting of the force action to the weight forces of the flap 3 to be compensated for can already be performed by the selection of a suitable position. Instead of the positioning options, a continuous presetting can also be provided, for example, in the form of a screw/nut connection, by which the position of the rod 23 in relation to the holder 18 can be changed.

The term “gear wheel” is understood to mean rotating disks having external gear teeth, wherein the external gear teeth extend alternately over the entire circumference or only a part of the circumference. Alternatively, toothed segments, internal gear teeth, or other components can be used as gear wheels, on which teeth are provided for the formfitting engagement with an adjacent gear wheel.

Furthermore, a damper 30 is provided on the housing 5, which is formed as a linear damper, in particular as a fluid, liquid, or air damper, which is held on a fastening element 31 on the housing 5 and comprises a piston-cylinder unit, which generates damping forces upon compression. On the side facing away from the fastening element 31, a contact surface 32 is provided, for example, a contact roller, which can be contacted by an actuating element 33 on the holder 18.

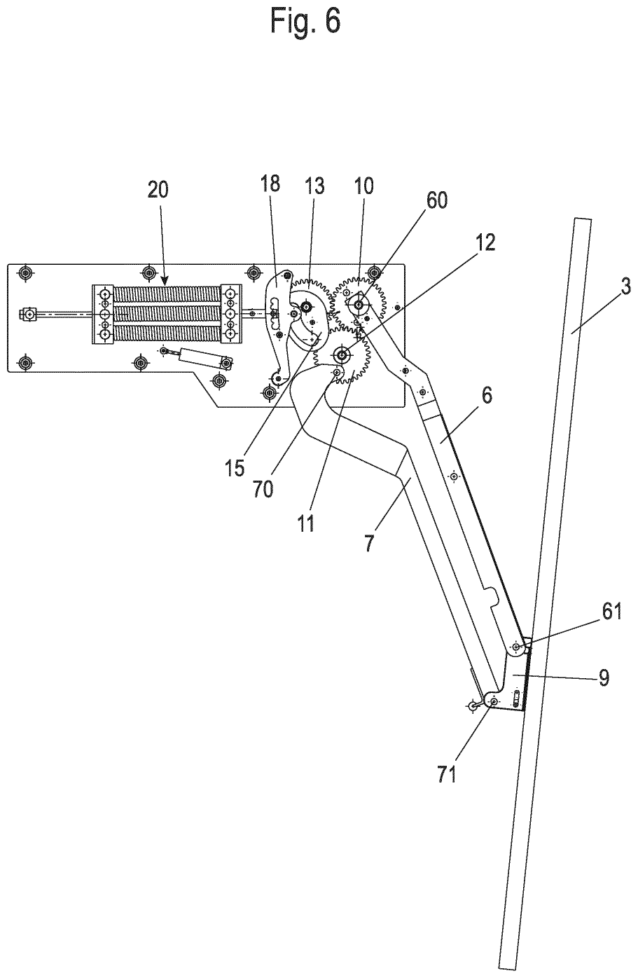

For an opening procedure, a handle arranged in the lower region of the flap 3 is actuated by a user to move the flap 3 forward and upward. The flap 3 is illustrated in a slightly open position in FIG. 6. The force accumulator 20 is further tensioned at the beginning of the opening movement, since the flap 3 is pre-tensioned in the closing direction in the range of the closed position. After overcoming a dead center, the force accumulator 20 assists the movement of the flap 3 in the opening direction.

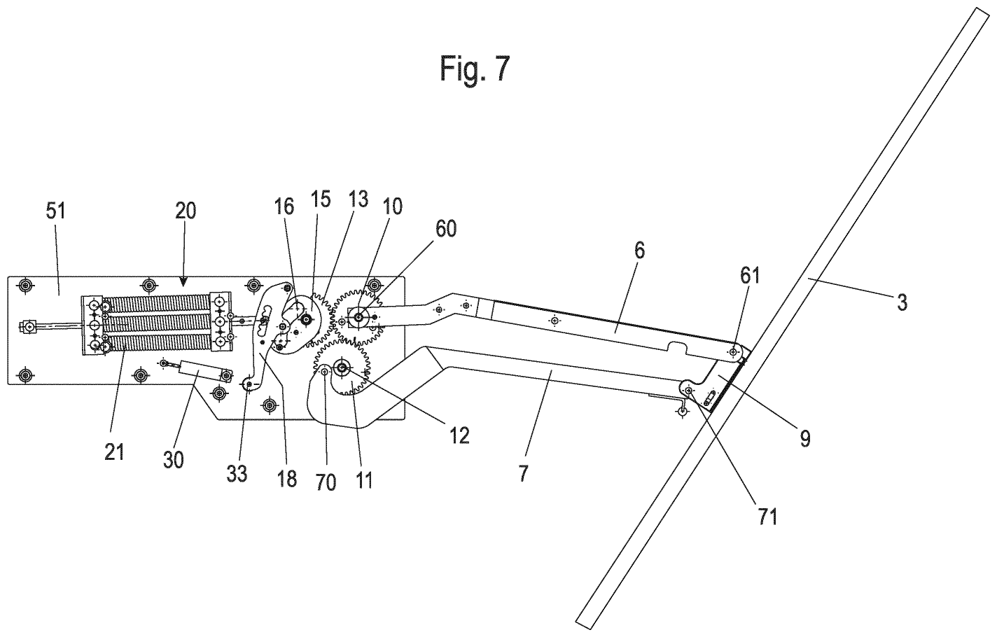

If the flap 3 is moved further in the opening direction, as shown in FIG. 7, both the supporting lever 6 pivots around the axis of rotation 60 and also the control lever 7 pivots around the axis of rotation 70, which is arranged on the rotatable gear wheel 11. From the closed position (FIG. 5) to the position in FIG. 7, the gear wheel 11 was rotated by approximately 90°, so that the axis of rotation 70 has also been displaced. The gear wheels 10 and 11 are engaged in this case, so that the two supporting levers 6 and the control lever 7 are coupled to one another both in the region of the housing 5 and also on the attachment 9. The third gear wheel 13, which rotates the control disk 15, is also driven by the rotation of the gear wheel 10. By rotating the control disk 15, the curve guide 16 is moved, which enables a contraction of the springs 21 of the force accumulator 20 during an opening movement after overcoming the dead center, so that the force accumulator 20 assists the opening procedure.

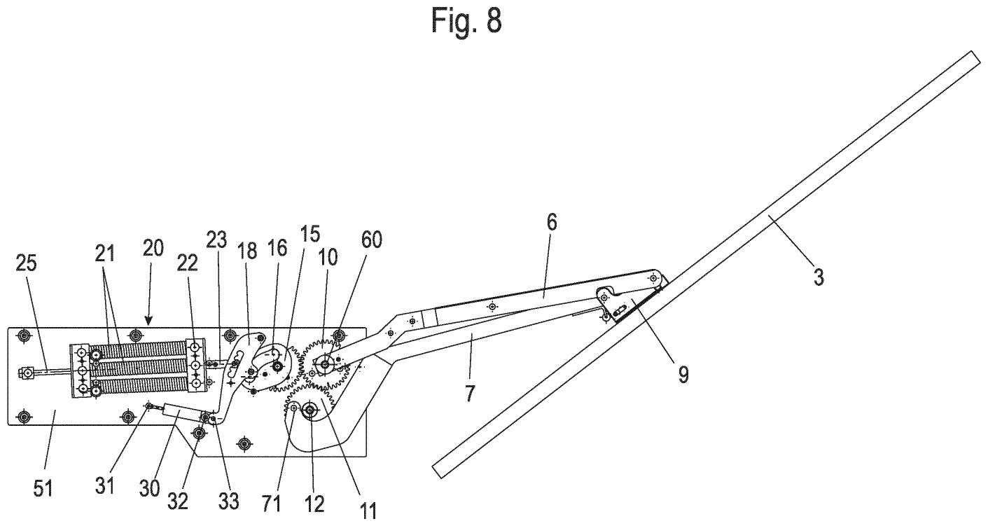

The flap 3 is moved further in the opening direction according to FIG. 8, wherein an upper end of the flap 3 protrudes forward and upward. A lower region of the flap moves essentially vertically upward shortly before the opening on the furniture body 2.

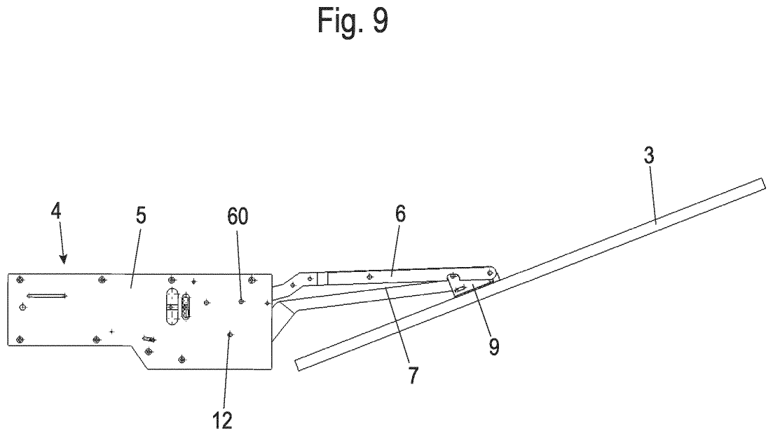

The maximally open position of the flap fitting 4 is shown in FIG. 9. The flap 3 is inclined slightly in relation to the horizontal, for example, in a region between 10° and 20°, and largely exposes the opening region on the furniture body 2. Before reaching the maximally open position, the opening movement can be decelerated, for example, by a damper, which is arranged in the attachment 9. Alternatively, or additionally, the damper 30 is provided in the housing 5, which is compressed by the actuating element 33 on the holder 18, as shown in FIG. 8.

For a closing movement, the user pulls the flap 3 downward against the force of the force accumulator 20 until the flap 3 is again arranged in the closed position illustrated in FIG. 5.

In the illustrated exemplary embodiment, three gear wheels 10, 11, and 13 are arranged in the housing 5. It is also possible to provide a gearing having a predetermined transmission ratio in the housing 5 in order to adapt the tensioning and release of the force accumulator 20 still more strongly to the weight of the flap 3 and other parameters.

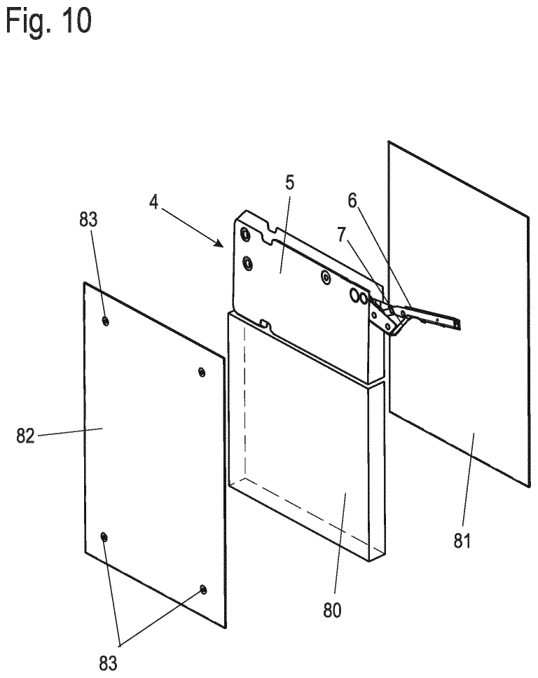

A flap fitting 4 is fastened on an inner side of a side wall of a furniture body 2 in each of FIGS. 1 to 9. In FIG. 10, the flap fitting 4 is not integrated on an inner side but rather in a side wall of the furniture body 2. For this purpose, the side wall comprises a plate-shaped core material 80, for example, made of a wooden material, adjacent to which the housing 5 of the flap fitting 4 is arranged, either over the entire width of the core material 80 or on an opening of the core material 80 which extends over only a part of the width of the core material 80. The housing 5 and the core material 80 are covered on the outer side by an outer layer 81 and on the inner side via an inner layer 82, wherein outer layer 81 and inner layer 82 can optionally also be embodied as structurally equivalent, for example, from a film or a decorative layer. In the illustrated exemplary embodiment, the inner layer 82 is fixed via fastening points on the core material 80 and the housing 5. The housing 5 can be adhesively bonded to the core material 5 or connected via fastening means. Due to the arrangement of the housing in the side wall of a furniture body, the housing is only visible from an end face with open flap 3 when the supporting lever 6 and the control lever 7 protrude forward.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 item of furniture
2 furniture body
3 flap
4 flap fitting
5 housing
6 supporting lever
7 control lever
8 rod
9 attachment
10 gear wheel
11 gear wheel
12 axis of rotation
13 gear wheel
14 axis of rotation
15 control disk
16 curve guide
17 guide element
18 holder
19 receptacle
20 force accumulator
21 spring
22 spring holder
23 rod
24 spring holder
25 fastening
30 damper
31 fastening element
32 contact surface
33 actuating element
50 side wall
51 side wall
52 spacer
60 axis of rotation
61 axis of rotation
70 axis of rotation
71 axis of rotation
80 core material
81 outer layer
82 inner layer
83 fastening points

1-10. (canceled)

11. A flap fitting for an item of furniture, wherein the flap fitting comprises:
a main body;
a supporting lever rotatably mounted on the main body; and
a control lever pivotably mounted on the main body,
wherein the supporting lever and the control lever are connectable in an articulated manner to a flap of the item of furniture via respective and spaced-apart axis of rotation, the supporting lever drives a first gear wheel during a rotational movement, the first gear wheel directly or indirectly drives a second gear wheel, and the control lever is rotatably mounted on the second gear wheel spaced apart from the axis of rotation of the second gear wheel.

12. The flap fitting of claim 11, further comprising:
a force accumulator configured to pre-tension the flap of the item of furniture in a closed position in a closing direction and to pre-tension the flap of the item of furniture in an opening range in an opening direction.

13. The flap fitting of claim 12, wherein the force accumulator is coupled via a rotatably mounted control disk to a third gear wheel.

14. The flap fitting of claim 13, further comprising:
a curve guide formed in the rotatably mounted control disk, wherein a holder connected to the force accumulator is guided on the curve guide.

15. The flap fitting of claim 11, wherein a gearing formed from at least the first and second gear wheels is arranged between two side walls of the main body.

16. The flap fitting of claim 11, further comprising:
a damper configured to decelerate an opening and/or closing movement of the flap of the item of furniture before reaching an end position.

17. The flap fitting of claim 11, further comprising:
an attachment configured for installation on the flap, wherein the axis of rotation for the supporting lever and the axis of rotation for the control lever are on the attachment.

18. The flap fitting of claim 17, further comprising:
a damper configured to decelerate an opening movement of the flap of the item of furniture is arranged on the attachment.

19. The flap fitting of claim 11, wherein the flap is movable with an upper section away from the flap fitting during an opening movement.

20. An item of furniture, comprising:
a furniture body;
a flap; and
two flap fittings coupling the flap to the furniture body, each of the two flap fittings comprising
a main body;
a supporting lever rotatably mounted on the main body; and
a control lever pivotably mounted on the main body,
wherein the supporting lever and the control lever are connectable in an articulated manner to a flap of the item of furniture via respective and spaced-apart axis of rotation, the supporting lever drives a first gear wheel during a rotational movement, the first gear wheel directly or indirectly drives a second gear wheel, and the control lever is rotatably mounted on the second gear wheel spaced apart from the axis of rotation of the second gear wheel.
